(19) United States
(12) Patent Application Publication
(10) Pub. No.: US 2023/0415253 A1
(43) Pub. Date: Dec. 28, 2023

(54) LIQUID METAL (LM) DISPENSING APPARATUS AND METHODS FOR DESIGN AND OPERATION OF SAME

(71) Applicant: Intel Corporation, Santa Clara, CA (US)

(72) Inventors: Sangeon Lee, Chandler, AZ (US); Tingting Gao, Chandler, AZ (US); Xiao Lu, Chandler, AZ (US); Matthew T. Magnavita, Chandler, AZ (US); Jiaqi Wu, Chandler, AZ (US)

(73) Assignee: Intel Corporation, Santa Clara, CA (US)

(21) Appl. No.: 17/851,968

(22) Filed: Jun. 28, 2022

(51) Int. Cl. B23K 3/06

(52) U.S. Cl. CPC B23K 3/0638; B23K 2101/40

(57) ABSTRACT

A liquid metal (LM) dispensing apparatus and method for design and fabrication thereof. Components of the LM dispensing apparatus are designed and tooled based on a target pinout (e.g., a number of, arrangement of, and dimensions of, holes in a substrate to have LM injected therein) and desired LM material. Embodiments employ detachably attached needles using a locking means to provide leak-free interchangeability of the needles. The flexibility with needles makes replacing damaged needles more perfunctory. Embodiments contour the LM reservoir to enhance uniform LM flow to the needles and dispense or inject LM from multiple detachably attached needles concurrently.

### BACKGROUND

Liquid metal (LM) is contemplated for use in many present and future large form-factor packaging technologies. Using LM for very fine geometries and high volumes presents technical challenges.

### BRIEF DESCRIPTION OF THE DRAWINGS

FIG. 1A and FIG. 1B are simplified illustrations of an exemplary LM dispensing apparatus, in accordance with various embodiments.

FIG. 2A is a simplified enlargement of a needle assembly region of the LM dispensing apparatus, in accordance with embodiments.

FIGS. 2B-2D illustrate variations in needle nozzles and needle attachment mechanisms for the LM dispensing apparatus, in accordance with various embodiments.

FIG. 3 is a top-down illustration of an array of LM interconnects, as may be concurrently injected by the LM dispensing apparatus, in accordance with various embodiments.

FIG. 4A and FIG. 4B are illustrations for discussion of the flexibility of identifying defect scenarios and replacing needles in the LM dispensing apparatus, in accordance with various embodiments.

FIG. 5 is a flow chart providing an example method for designing and operating a LM dispensing apparatus, in accordance with various embodiments.

FIG. 6 is a top view of a wafer and dies that may have LM interconnects added to them, in accordance with any of the embodiments disclosed herein.

FIG. 7 is a simplified cross-sectional side view showing an implementation of an integrated circuit on a die that may implement LM interconnects dispensed in accordance with any of the embodiments disclosed herein.

FIG. 8 is a cross-sectional side view of a microelectronic assembly that may include LM interconnects dispensed by embodiments disclosed herein.

FIG. 9 is a block diagram of an example electrical device that may include LM interconnects dispensed by embodiments disclosed herein.

### DETAILED DESCRIPTION

The following detailed description is merely exemplary in nature and is not intended to limit the application and uses. It may be evident that the novel embodiments can be practiced without every detail described herein. For the sake of brevity, well known structures and devices may be shown in block diagram form in order to facilitate a description thereof.

Liquid metal (LM) is contemplated for use in many present and future large form-factor packaging technologies. The use of Liquid Metal (LM) in the fabrication of semiconductor packaging and electrical test socketing has several benefits. A LM array socket provides a conductive medium between a pin and a pad; this electrical interconnection has a much lower insertion load compared to the insertion load of a conventional land grid array (LGA). Accordingly, LM is promising for pin-count scaling for future large form-factor devices.

However, dispensing LM in a highly ordered control and repetitive manner presents a technical challenge. In addition to accurate control of the dispensing of the LM (generally, through needles), a high throughput and fast cycle time are important to enable high volume manufacturing (HVM). Some available multi-point dispensing equipment struggles to provide reliable volume control across holes in a target substrate when the holes receive volumes of LM that are less than one microliter. There are various reasons that filling LM into every hole in an array of holes, evenly, and concurrently, may be extremely challenging. Some non-limiting reasons for the challenge include an internal turbulent flow in the reservoir holding the LM material, friction in individual needles, and a non-uniform distribution of stress across the needles. In some scenarios, an existing multi-point needle dispensing tool may be fabricated with unibody components that are difficult to manufacture and scale. Also, needles can be vulnerable to impact and bent or broken quite easily, responsive to the stress across the needles. Bent and/or broken needles can lead to uneven filling of a hole and/or to poor uniformity in shape of LM deposited across an array.

The present disclosure provides a technical solution to the above-described problems, in the form of a novel LM dispensing apparatus and method for design and fabrication thereof. The design of the LM dispensing apparatus is based on a target pinout (e.g., a number of, an arrangement of, and dimensions of holes in a substrate to have LM injected therein) and desired LM material. Embodiments employ detachably attached needles and propose novel variations in needle nozzles. The proposed flexibility with needles makes replacing damaged needles more perfunctory. Embodiments contour the LM reservoir to enhance uniform LM flow to the needles. An advantage of proposed embodiments is that a small amount of LM volume can be accurately controlled, while maintaining a rapid cycle time. Specifically, embodiments dispense or inject LM from multiple detachably attached needles concurrently. Experimental and simulation results indicate that provided embodiments can deliver high uniformity and accuracy at the same time, and that provided embodiments are effective for use with LM materials that vary from a low to a high viscosity. For at least the aforementioned reasons, the provided LM dispensing apparatus is conducive to high volume manufacturing (HVM) environments.

Exemplary embodiments will hereinafter be described in conjunction with the following drawing figures, wherein like numerals denote like elements. Figures are not necessarily to scale but may be relied on for spatial orientation and relative positioning of features. As may be appreciated, certain terminology, such as “ceiling” and “floor”, as well as “upper,”, “uppermost”, “lower,” “above,” “below,” “bottom,” and “top” refer to directions based on viewing the Figures to which reference is made. Further, terms such as “front,” “back,” “rear,”, “side”, “vertical”, and “horizontal” may describe the orientation and/or location of portions of the component within a consistent but arbitrary frame of reference which is made clear by reference to the text and the associated Figures describing the component under discussion. Such terminology may include the words specifically mentioned above, derivatives thereof, and words of similar import.

As used herein, the term “adjacent” refers to layers or components that are in direct physical contact with each other, with no layers or components in between them. For example, a layer X that is adjacent to a layer Y refers to a layer that is in direct physical contact with layer Y. In contrast, as used herein, the phrase(s) “located on” (in the alternative, “located under,” “located above/over,” or “located next to,” in the context of a first layer or component located on a second layer or component) includes (i) configurations in which the first layer or component is directly physically attached to the second layer (i.e., adjacent), and (ii) component and configurations in which the first layer or component is attached (e.g. coupled) to the second layer or component via one or more intervening layers or components.

The term “overlaid” (past participle of “overlay”) may be used to refer to a layer to describe a location and orientation for the layer but does not imply a method for achieving the location and orientation. For example, a first layer overlaid on a second layer, or overlaid on a component means that the first layer is spread across or superimposed on the second layer or component. Accordingly, a layer that is overlaid on a second layer may be viewed in a cross-sectional view as adjacent to the second layer.

As used herein, the term “electronic component” can refer to an active electronic circuit (e.g., processing unit, memory, storage device, FET) or a passive electronic circuit (e.g., resistor, inductor, capacitor).

As used herein, the term “integrated circuit component” can refer to an electronic component configured on a semiconducting material to perform a function. An integrated circuit (IC) component can comprise one or more of any computing system components described or referenced herein or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged integrated circuit component includes a single monolithic integrated circuit die (shortened herein to “die”); the die may include solder bumps attached to contacts on the die. When present on the die, the solder bumps or other conductive contacts can enable the die to be directly attached to a printed circuit board (PCB).

A non-limiting example of a packaged integrated circuit component comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps or leads attached to the package substrate for attaching the packaged integrated circuit component to a printed circuit board or motherboard.

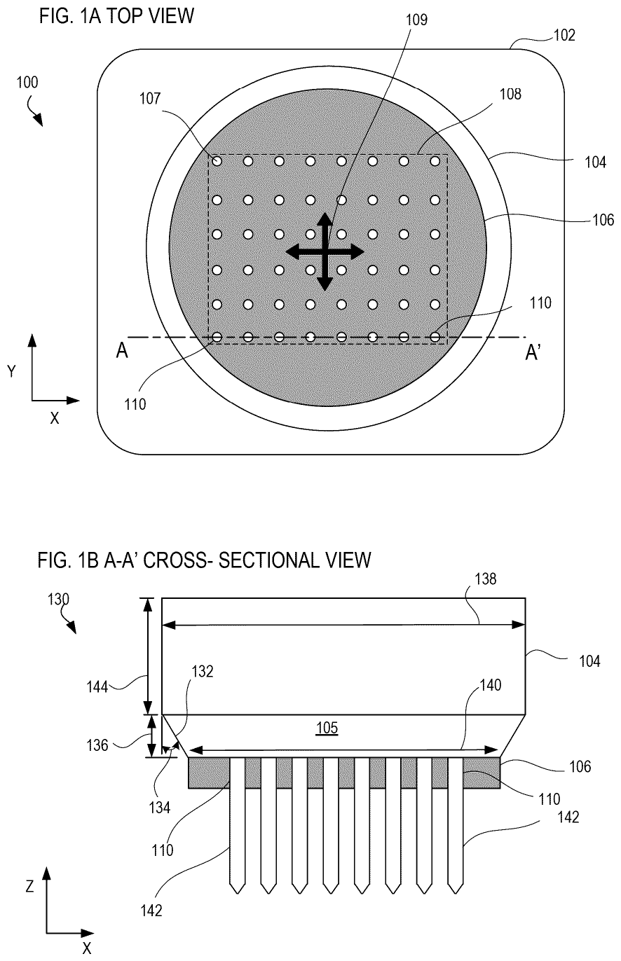

FIG. 1A and FIG. 1B are simplified illustrations of an exemplary LM dispensing apparatus, in accordance with various embodiments. Top view 100 illustrates LM dispensing tool 102 including a reservoir 104 having a base plate (shortened herein to “plate” 106). Plate 106 has a plurality of through-holes or openings 110. The openings 110 are organized in an arrangement 108. In various embodiments, arrangement 108 is a pinout for LM interconnects for a target die or chiplet. In a non-limiting example, the arrangement is a 6×6 array. FIG. 1B provides a cross-sectional view through A-A′.

Reservoir 104 is designed to have an internal profile that is a function of fluid dynamics modeling of the base plate 106 arrangement of holes (e.g., pinout) to be filled, the LM material, and the needles to be used. The fluid dynamics modeling is performed to improve uniformity of concurrent dispensing of LM by needles in a given arrangement. Specifically, the modeling of the LM fluid flow for a particular application enhances the likelihood that LM in each needle is approximately the same, and therefore, the distribution of LM across a pinout and between a center 109 and a corner 107 is homogeneous. Accordingly, the reservoir 104 is designed to include a chamfer region 105.

While the drawings are not to scale, the relationship of the plate having a smaller cross-sectional area (as indicated by width or diameter 140 measured around the pinout region) than a cross-sectional area of an upper opening of the reservoir 104 (as indicated by a width or diameter 138) can be relied upon. The reservoir 104 includes an upper region with a substantially perpendicular wall having height 144. The reservoir 104 is contoured above the plate 106, including the chamfer region 105, which is characterized by a slope or chamfer 132. Chamfer region 105 comprises a chamfer height 136; an overall height of the reservoir 104 is equal to chamfer height 136 plus height 144. In various embodiments, the chamfer height 136 is in a range of about 10% to about 70% of the overall height of the reservoir 104, wherein “about” means+/−5%. The “chamfer” in the chamfer region 105 serves to reduce the cross-sectional area of the reservoir 104 as the reservoir meets the base plate 106; the chamfer is located along an inner face of the reservoir 104, and at an end of the reservoir 104 that attaches to the base plate 106. Said differently, the reservoir 104 comprises a region of diminished cross-sectional area (chamfer region 105), and the plate 106 is attached to the reservoir at the region of diminished cross-sectional area.

In some embodiments, the reservoir 104 and chamfer region 105 may be circular and the chamfer 132 may be continuous radially around the center 109, as illustrated in FIG. 1A. In other embodiments, the reservoir 104 and chamfer region 105 are not necessarily circular. The chamfer 132 may be characterized with an angle 134 that is measured from perpendicular to the wall of the upper opening of the reservoir 104, as illustrated in FIG. 1B. Angle 134 may be in a range of about 20 degrees to about 60 degrees.

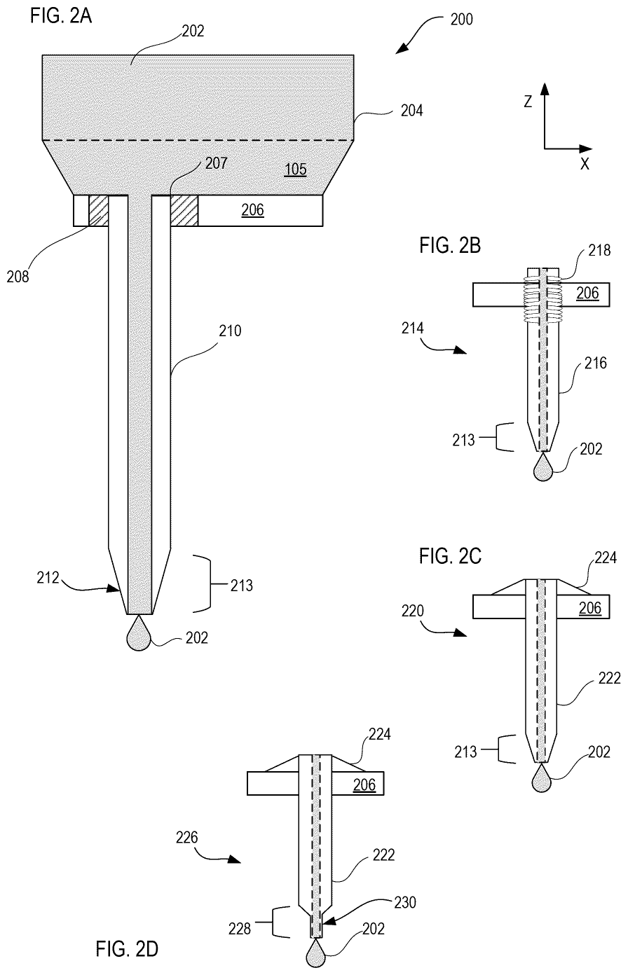

A needle 142 is detachably attached to an opening 110 in the plate 106. As is developed more in connection with FIGS. 2, the needle 142 provides a fluid path for LM to travel from a first end to a second end. In some embodiments, at least two of the openings out of all the openings in the arrangement have a respective needle detachably attached thereto. In embodiments having a plurality of openings in an arrangement 108, a respective needle 142 may be attached to individual of the openings 110, in a 1:1 correspondence, as illustrated in FIG. 1B. Stated differently, in embodiments that have a plurality of needles, individual openings of the arrangement of openings have a respective detachably attached needle.

For further discussion of the needles 142, the needle region of an exemplary LM dispensing apparatus is enlarged in FIG. 2A. In FIG. 2A, a simplified rendering of LM dispensing apparatus 200 depicts the reservoir 204 with the chamfer region 105 located adjacent to the plate 206. The needle 210 is detachably attached to the plate 206, in an opening 207 of the plate 206. Although the needle 210 is illustrated in two dimensions, the needle is a three-dimensional object with a through-hole, as known by those with skill in the art. The needle 210 receives LM 202 at a first end and dispenses LM 202 at a second end (also referred to as the nozzle). In FIG. 2A, the reservoir 204 is shown having therein a LM 202 material. In various embodiments, the liquid metal (LM) 202 can comprise any suitable liquid metal that is liquid at normal operating temperatures of a substrate assembly. In some embodiments, the LM comprises gallium or an alloy of gallium, such as, for example, alloys of gallium and indium, eutectic alloys of gallium, indium, and tin, and eutectic alloys of gallium, indium, and zinc. In various applications, the LM may be Ga₂O₃.

The second end of the needle 210 may be characterized with a nozzle 213. In various embodiments, the nozzle 213 has a chamfer 212. In various embodiments, the chamfer 212 of the needle may be a function of a dimension of an opening in a substrate to be injected with LM (e.g., an opening for an LM interconnect on a substrate). The target pinout may be a function of intended use for a Second Level Interconnect (SLI) or a First Level Interconnect (FLI). In various embodiments, the needle 210 may be custom tooled to include the chamfer 212.

An attachment means 208, or locking mechanism 208 or locking means 208, may be used to detachably attach the needle 210 to the base plate 206. Individual of the locking mechanisms 208 are associated with a respective needle. The locking mechanism 208 selected provides leak-free interchangeability of needles. The locking mechanism is designed to be mechanically robust and simple to operate. FIGS. 2B-2D illustrate some non-limiting variations in needle nozzles and locking mechanisms 208 for the LM dispensing apparatus, in accordance with various embodiments. In various embodiments, the needle 210, locking mechanism 208, and nozzle 213 are collectively referred to as a needle assembly, and components of a needle assembly can be flexibly replaced during operation of the LM dispensing apparatus.

In FIG. 2B, the locking mechanism comprises a Luer lock 218 configured to attach to the plate. The Luer lock 218 is a standardized system of small-scale fluid fittings used for making leak-free connections between a male-taper fitting and its mating female part on laboratory instruments, including syringe tips and needles. A Luer lock 218 allows a needle 210 to be twisted onto the tip and then locked in place. In addition to the Luer taper locking system, a Luer slip could be also considered. The Luer slip (also referred to as slip-tip) attachments requires that the needle be pushed onto a syringe end, creating a secure connection. Luer-slip fittings simply conform to Luer taper dimensions and are pressed together and held by friction (they have no threads). Luer components may be manufactured from either metal or plastic and are widely available. In various embodiments, the needle 216 may be custom designed to have the Luer lock 218 integrated with the needle 216.

In FIG. 2C, the locking mechanism comprises a Clip lock 224, and can be attached to and detached from the plate 206 by a clip movement at an opening 207 configured to receive the Clip lock. In various embodiments, the needle 222 may be custom designed to have the Clip lock 224 integrated with the needle 222. This Clip lock 224 incorporates a simple lever and clip structure which will safely lock a needle 222 to a base plate 206 and guard structure and which, in a simple mode, enables separation of the damaged needle 222 from the base plate 206 upon retraction. A further embodiment is adapted to enable separation between the base plate and the needle insertion by simply manipulating a lever arranged on a needle assembly by simply pushing against a push-tab element. This locking mechanism enables an operator to release the damaged needle by employing only one hand.

In FIG. 2D, the locking mechanism comprises a Clip lock 224, and the needle 222 may be custom designed to have the Clip lock 224 integrated with the needle 222, as described above. Additionally, FIG. 2D illustrates a nozzle 228 in which the chamfer region is truncated and feeds into a conical portion 230. The nozzle 228 may be custom tooled and integrated into the needle 222. The nozzle 228 may also be custom tooled and integrated with a needle that has a Luer lock 218.

In accordance with the above description, having customized the reservoir 104 shape, customized the needles, customized the locking mechanisms, customized the arrangement of holes in the base plate 106 (to match a target pinout and to receive the detachably attached needles), and having selected the LM 202 material, the LM dispensing apparatus 102 may be placed into operation in a manufacturing environment. As mentioned, the needles are arranged for a target pinout, the target may be a wafer, a die, a chiplet, a substrate, or the like. Embodiments of a LM dispensing apparatus may dispense or inject LM 202 from multiple detachably attached needles onto the target, concurrently. During operation of the LM dispensing apparatus, inspections may be performed on the LM on the target die, wafer, substrate, or chiplet.

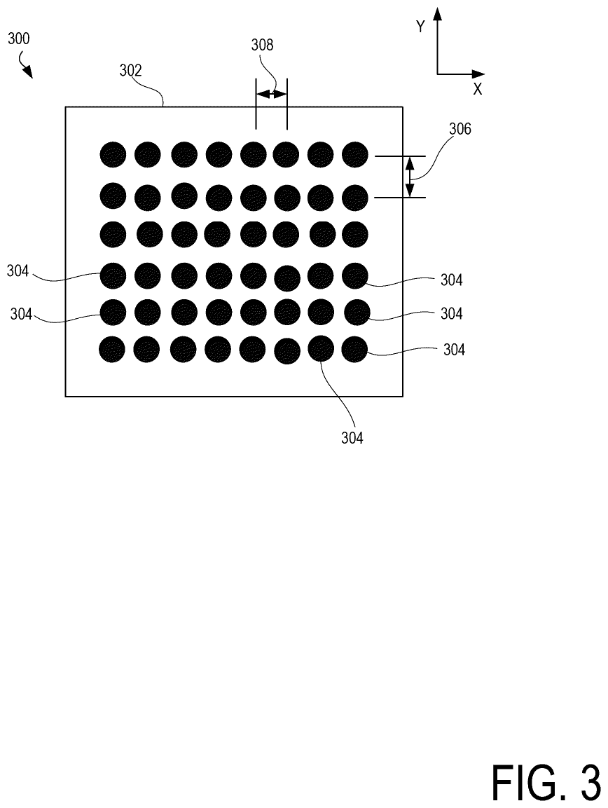

When components of the LM dispensing apparatus are operating to design, the inspections may reveal that LM dispensing meets requirements, and LM injection is accurately controlled. Moving to FIG. 3, a top-down illustration 300 of an exemplary array 302 of LM interconnects 304, as may be concurrently injected by the LM dispensing apparatus, is depicted. Although the drawing is not to scale, it may be relied upon that the spacing geometries (the distance between columns 308 and distance between rows 306) is substantially uniform and consistent with the needs for the target pinout. In various embodiments, the LM interconnects 304 may be on a wafer. In various embodiments, the spacing geometries supported by the LM dispensing apparatus can be less than 100 μm and may be suitable for architectures on both Second Level Interconnect (SLI) and First Level Interconnect (FLI). Additionally, as illustrated in FIG. 3, the amount of LM and subsequent shape of the dispensed LM, is substantially uniform (as used herein, substantially means+/−10%). In addition to auding a manufacturing line, use of the LM dispensing apparatus may be confirmed via visual inspection, e.g., by using a 2D/3D X-ray of a cross-section, Optical Microscopy, or scanning electron microscopy (SEM) to view meniscus shape and meniscus uniformity for the LM material in use. In some scenarios, sensors may be used to detect uniformity of LM distribution, and shape. In addition, various reverse engineering techniques may reveal the use of the described LM dispensing apparatus.

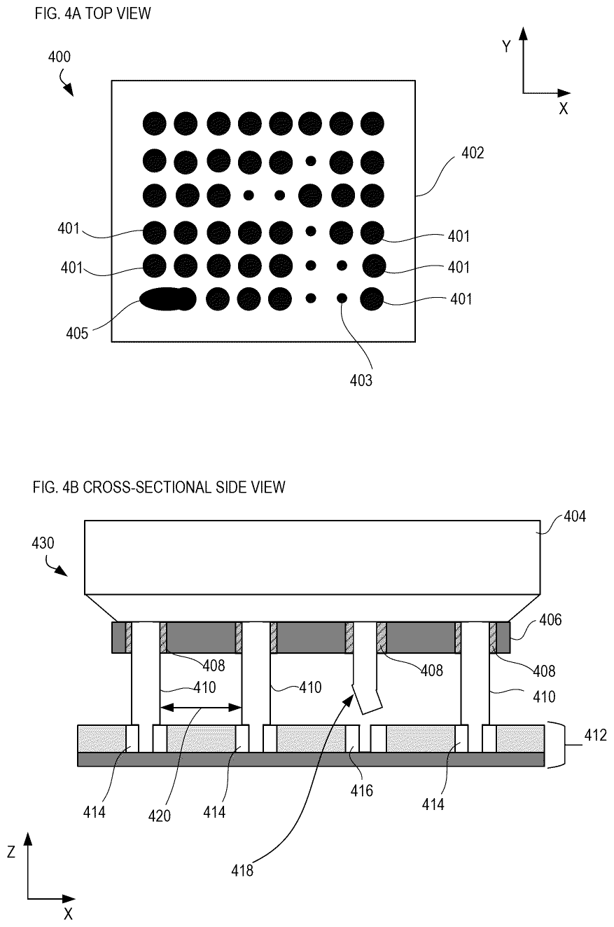

If an inspection reveals that the LM dispensing has not met requirements, culprit needles and/or needle assemblies can quickly and detachably be replaced. FIG. 4A and FIG. 4B are illustrations for discussion of the flexibility of identifying defect scenarios and replacing needles in the LM dispensing apparatus, in accordance with various embodiments. In FIG. 4A, top-down illustration 400 of an exemplary array 402 illustrates some non-limiting examples of defect scenarios that can result from needle failures, for which the provided embodiments can be flexibly and quickly corrected.

LM interconnects 401 are determined to meet requirements in size, uniformity, and placement. LM interconnect 405 depicts an overfill defect, in which too much LM was deposited, and consequently, two neighbor LM interconnects have incorrectly been connected together. LM interconnect 403 depicts an absence of (or in the alternative, not enough of) the LM material being deposited on the target. The defects illustrated as 405 and 403 may be visually identified under magnification and/or may be identified using a sensing apparatus. Regardless of the method for identifying any defects, a location on the LM dispensing apparatus for which there is a culprit non-functioning needle can be mapped, based on a location of the identified defect.

In the illustration of FIG. 4B, LM dispensing apparatus 430 comprises reservoir 404 and base plate 406. Locking mechanisms 408 detachably attach needles 410 to the base plate 406. Needles 410 are uniformly separated by a distance 420, that is responsive to a target pinout, such as, to become LM interconnects on a substrate 412. For the working needles 410, the LM material may be deposited into holes 414 created to become functional LM interconnects. At needle location 418, there may be a non-functioning needle (i.e., a damaged, broken, bent, or missing needle). A subsequent defect at the LM interconnect location 416 may be identified via inspection, post-LM injection. As described herein, the non-functioning needle can be quickly and easily (sometimes with one hand) be replaced with a new, working needle.

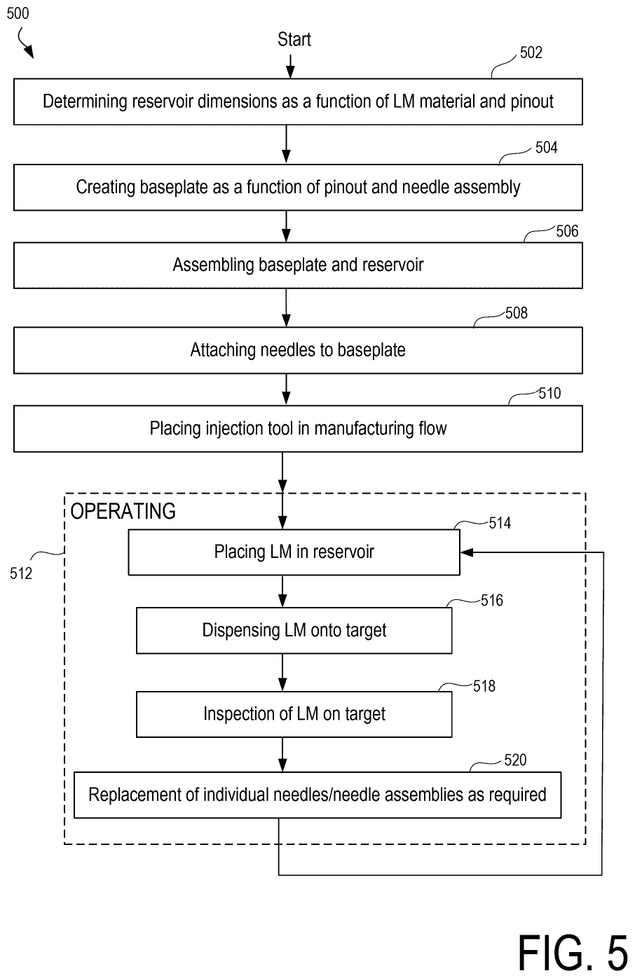

FIG. 5 is a flow chart providing an example method for designing and operating a LM dispensing apparatus, in accordance with various embodiments. Operations 502 through 508 summarize the design and build of the LM dispensing apparatus. Operations 514-520 (collectively operation 512) represent operating the LM dispensing apparatus.

At 502, reservoir 104 dimensions are determined. As described above, the internal profile of the reservoir, and specifically, the dimensions of the chamfer region 105, are based on several factors. The factors include the material used for the LM, because that has a distinct viscosity, and the target pinout or arrangement of needles. The arrangement of needles may be informed by the function of the die or chiplet to receive the LM interconnects. The fluid modeling will be performed to enhance a consistency of delivery of LM to needles. Upon determining the reservoir dimensions, the reservoir 104 is constructed or tooled.

At 504, the plate 106 may be created. The plate 106 is created with appropriate area to receive the through-holes or openings therethrough, spaced in accordance with a target pinout, and to be configured for having the needles of choice attached with the detachable locking mechanisms of choice. Each of these pieces can be custom tooled. The openings may be treated to resist corrosion. At 506, the plate 106 is attached to the chamfer region 105 of the reservoir 104, such that the openings allow fluid communication with the chamfer region 105. Prior to attaching the needles to the plate, the needles may be custom designed and tooled for the target pinout, as described above. At 508, the needles are attached to the plate 106, in a ratio of one needle to one opening. At 510, the LM dispensing tool may be placed into a manufacturing flow.

At 512 the LM dispensing tool may be placed into operation. To begin and to continue operating, LM is placed in the reservoir 104 at 514. At 516, LM is dispensed onto a target. As described herein, the LM is dispensed into holes in a substrate, or another target, by all of the needles attached to the plate 106, concurrently. At 518, the target may be inspected to determine the LM injection or deposition performance. If an inspection determines that there is a non-functioning needle, the non-functioning needle is located and replaced at 520. Advantageously, responsive to identifying a defect, at 520, neither the entire LM dispensing apparatus, nor the entire plate 106, nor all of the needles, need to be replaced. Operations 514 through 520 may be repeated in a high-volume manufacturing environment.

Accordingly, various non-limiting embodiments of a LM dispensing apparatus and methods for making and operating it have been described. There are various scenarios and end products that may employ the LM dispensing apparatus.

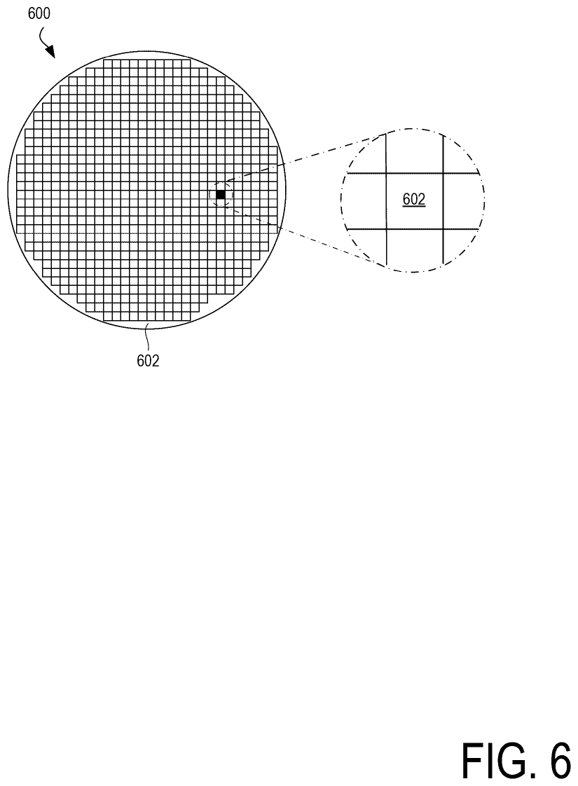

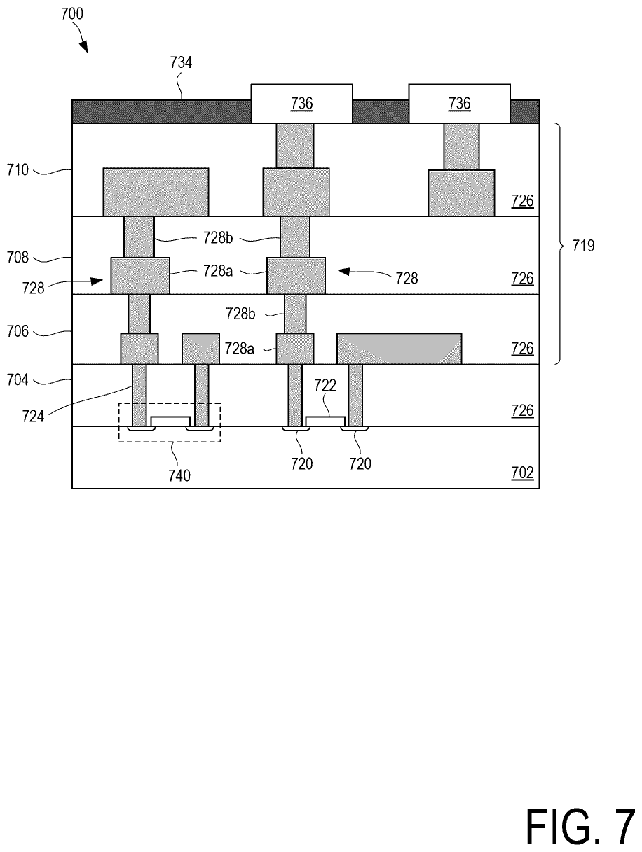

FIG. 6 is a top view of a wafer 600 and dies 602 that may receive LM onto LM interconnects from embodiments disclosed herein. The wafer 600 may be composed of semiconductor material and may include one or more dies 602 formed on a surface of the wafer 600. After the fabrication of the integrated circuit components on the wafer 600 is complete, the wafer 600 may undergo a singulation process in which the dies 602 are separated from one another to provide discrete “chips” or destined for a packaged integrated circuit component. The individual dies 602, comprising an integrated circuit component, may include one or more transistors (e.g., some of the transistors 740 of FIG. 7, discussed below), supporting circuitry to route electrical signals to the transistors, passive components (e.g., signal traces, resistors, capacitors, or inductors), and/or any other integrated circuit components. In some embodiments, the wafer 600 or the die 602 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 602. For example, a memory array formed by multiple memory devices may be formed on a same die 602 as a processor unit or other logic that is configured to store information in the memory devices or execute instructions stored in the memory array. In some embodiments, a die 602 may be attached to a wafer 600 that includes other die, and the wafer 600 is subsequently singulated, this manufacturing procedure is referred to as a die-to-wafer assembly technique.

FIG. 7 is a cross-sectional side view of an integrated circuit 700 that may be included in any of the embodiments disclosed herein. One or more of the integrated circuits 700 may be included in one or more dies 602 (FIG. 6). The integrated circuit 700 may be formed on a die substrate 702 (e.g., the wafer 600 of FIG. 6) and may be included in a die (e.g., the die 602 of FIG. 6).

The die substrate 702 may be a semiconductor substrate composed of semiconductor material systems including, for example, n-type or p-type materials systems (or a combination of both). The die substrate 702 may include, for example, a crystalline substrate formed using a bulk silicon or a silicon-on-insulator (SOI) substructure. In some embodiments, the die substrate 702 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 702. Although a few examples of materials from which the die substrate 702 may be formed are described here, any material that may serve as a foundation for an integrated circuit 700 may be used. The die substrate 702 may be part of a singulated die (e.g., the dies 602 of FIG. 6) or a wafer (e.g., the wafer 600 of FIG. 6).

The integrated circuit 700 may include one or more device layers 704 disposed on the die substrate 702. The device layer 704 may include features of one or more transistors 740 (e.g., metal oxide semiconductor field-effect transistors (MOSFETs)) formed on the die substrate 702. The transistors 740 may include, for example, one or more source and/or drain (S/D) regions 720, a gate 722 to control current flow between the S/D regions 720, and one or more S/D contacts 724 to route electrical signals to/from the S/D regions 720.

The gate 722 may be formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be conducted on the gate dielectric to improve its quality when a high-k material is used.

The gate electrode may be formed on the gate dielectric and may include at least one p-type work function metal or n-type work function metal, depending on whether the transistor 740 is to be a p-type metal oxide semiconductor (PMOS) or an n-type metal oxide semiconductor (NMOS) transistor. In some implementations, the gate electrode may comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 740 along the source-channel-drain direction, the gate electrode may comprise a U-shaped structure that includes a bottom portion substantially parallel to the surface of the die substrate 702 and two sidewall portions that are substantially perpendicular to the top surface of the die substrate 702. In other embodiments, at least one of the metal layers that form the gate electrode may simply be a planar layer that is substantially parallel to the top surface of the die substrate 702 and does not include sidewall portions substantially perpendicular to the top surface of the die substrate 702. In other embodiments, the gate electrode may comprise a combination of U-shaped structures and planar, non-U-shaped structures. For example, the gate electrode may comprise one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 720 may be formed within the die substrate 702 adjacent to the gate 722 of individual transistors 740. The S/D regions 720 may be formed using an implantation/diffusion process or an etching/deposition process, for example. In the former process, dopants such as boron, aluminum, antimony, phosphorous, or arsenic may be ion-implanted into the die substrate 702 to form the S/D regions 720. An annealing process that activates the dopants and causes them to diffuse farther into the die substrate 702 may follow the ion-implantation process. In the latter process, the die substrate 702 may first be etched to form recesses at the locations of the S/D regions 720. An epitaxial deposition process may then be conducted to fill the recesses with material that is used to fabricate the S/D regions 720. In some implementations, the S/D regions 720 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 720 may be formed using one or more alternate semiconductor materials such as germanium or a group III-V material or alloy. In further embodiments, one or more layers of metal and/or metal alloys may be used to form the S/D regions 720.

Electrical signals, such as power and/or input/output (I/O) signals, may be routed to and/or from the devices (e.g., transistors 740) of the device layer 704 through one or more interconnect layers disposed on the device layer 704 (illustrated in FIG. 7 as interconnect layers 706-710). For example, electrically conductive features of the device layer 704 (e.g., the gate 722 and the S/D contacts 724) may be electrically coupled with the interconnect structures 728 of the interconnect layers 706-710. The one or more interconnect layers 706-710 may form a metallization stack (also referred to as an “ILD stack”) 719 of the integrated circuit 700.

The interconnect structures 728 may be arranged within the interconnect layers 706-710 to route electrical signals according to a wide variety of designs; in particular, the arrangement is not limited to the particular configuration of interconnect structures 728 depicted in FIG. 7. Although a particular number of interconnect layers 706-710 is depicted in FIG. 7, embodiments of the present disclosure include integrated circuits having more or fewer interconnect layers than depicted.

In some embodiments, the interconnect structures 728 may include lines 728a and/or vias 728b filled with an electrically conductive material such as a metal. The lines 728a may be arranged to route electrical signals in a direction of a plane that is substantially parallel with a surface of the die substrate 702 upon which the device layer 704 is formed. For example, the lines 728a may route electrical signals in a direction in and out of the page and/or in a direction across the page. The vias 728b may be arranged to route electrical signals in a direction of a plane that is substantially perpendicular to the surface of the die substrate 702 upon which the device layer 704 is formed. In some embodiments, the vias 728b may electrically couple lines 728a of different interconnect layers 706-710 together.

The interconnect layers 706-710 may include a dielectric material 726 disposed between the interconnect structures 728, as shown in FIG. 7. In some embodiments, dielectric material 726 disposed between the interconnect structures 728 in different ones of the interconnect layers 706-710 may have different compositions; in other embodiments, the composition of the dielectric material 726 between different interconnect layers 706-710 may be the same. The device layer 704 may include a dielectric material 726 disposed between the transistors 740 and a bottom layer of the metallization stack as well. The dielectric material 726 included in the device layer 704 may have a different composition than the dielectric material 726 included in the interconnect layers 706-710; in other embodiments, the composition of the dielectric material 726 in the device layer 704 may be the same as a dielectric material 726 included in any one of the interconnect layers 706-710.

A first interconnect layer 706 (referred to as Metal 1 or “M1”) may be formed directly on the device layer 704. In some embodiments, the first interconnect layer 706 may include lines 728a and/or vias 728b, as shown. The lines 728a of the first interconnect layer 706 may be coupled with contacts (e.g., the S/D contacts 724) of the device layer 704. The vias 728b of the first interconnect layer 706 may be coupled with the lines 728a of a second interconnect layer 708.

The second interconnect layer 708 (referred to as Metal 2 or “M2”) may be formed directly on the first interconnect layer 706. In some embodiments, the second interconnect layer 708 may include via 728b to couple the lines 728 of the second interconnect layer 708 with the lines 728a of a third interconnect layer 710. Although the lines 728a and the vias 728b are structurally delineated with a line within individual interconnect layers for the sake of clarity, the lines 728a and the vias 728b may be structurally and/or materially contiguous (e.g., simultaneously filled during a dual-damascene process) in some embodiments.

The third interconnect layer 710 (referred to as Metal 3 or “M3”) (and additional interconnect layers, as desired) may be formed in succession on the second interconnect layer 708 according to similar techniques and configurations described in connection with the second interconnect layer 708 or the first interconnect layer 706. In some embodiments, the interconnect layers that are “higher up” in the metallization stack 719 in the integrated circuit 700 (i.e., farther away from the device layer 704) may be thicker that the interconnect layers that are lower in the metallization stack 719, with lines 728a and vias 728b in the higher interconnect layers being thicker than those in the lower interconnect layers.

The integrated circuit 700 may include a solder resist material 734 (e.g., polyimide or similar material) and one or more conductive contacts 736 formed on the interconnect layers 706-710. In FIG. 7, the conductive contacts 736 are illustrated as taking the form of bond pads. The conductive contacts 736 may be electrically coupled with the interconnect structures 728 and configured to route the electrical signals of the transistor(s) 740 to external devices. For example, solder bonds may be formed on the one or more conductive contacts 736 to mechanically and/or electrically couple an integrated circuit die including the integrated circuit 700 with another component (e.g., a printed circuit board). The integrated circuit 700 may include additional or alternate structures to route the electrical signals from the interconnect layers 706-710; for example, the conductive contacts 736 may include other analogous features (e.g., posts) that route the electrical signals to external components.

In some embodiments in which the integrated circuit 700 is a double-sided die, the integrated circuit 700 may include another metallization stack (not shown) on the opposite side of the device layer(s) 704. This metallization stack may include multiple interconnect layers as discussed above with reference to the interconnect layers 706-710, to provide conductive pathways (e.g., including conductive lines and vias) between the device layer(s) 704 and additional conductive contacts (not shown) on the opposite side of the integrated circuit 700 from the conductive contacts 736.

In other embodiments in which the integrated circuit 700 is a double-sided die, the integrated circuit 700 may include one or more through silicon vias (TSVs) through the die substrate 702; these TSVs may make contact with the device layer(s) 704, and may provide conductive pathways between the device layer(s) 704 and additional conductive contacts (not shown) on the opposite side of the integrated circuit 700 from the conductive contacts 736. In some embodiments, TSVs extending through the substrate can be used for routing power and ground signals from conductive contacts on the opposite side of the integrated circuit 700 from the conductive contacts 736 to the transistors 740 and any other components integrated into the die 700, and the metallization stack 719 can be used to route I/O signals from the conductive contacts 736 to transistors 740 and any other components integrated into the die 700.

Multiple integrated circuits 700 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

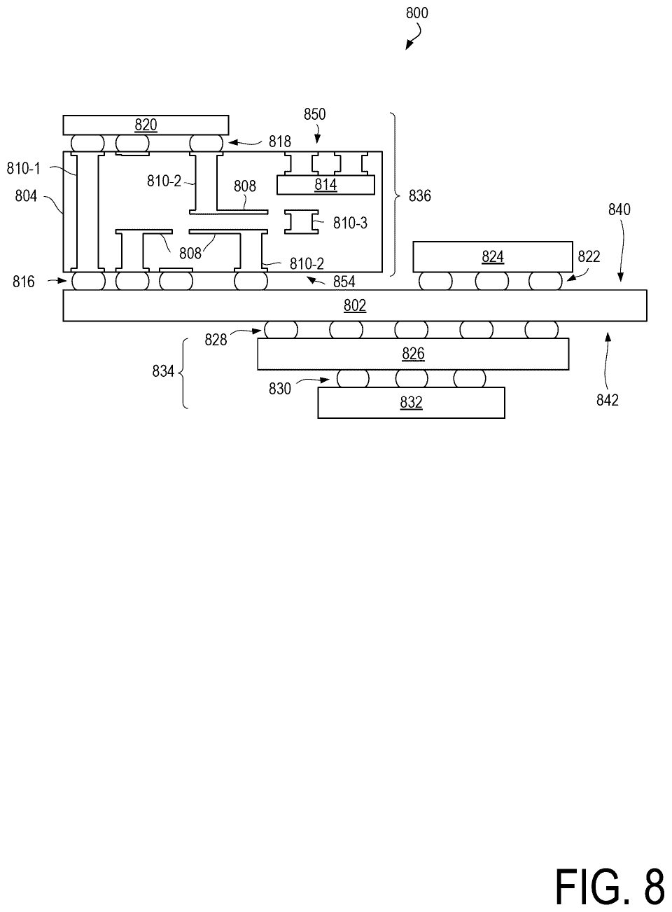

FIG. 8 is a cross-sectional side view of a microelectronic assembly 800 that may include any of the embodiments disclosed herein. The microelectronic assembly 800 includes multiple integrated circuit components disposed on a circuit board 802 (which may be a motherboard, system board, mainboard, etc.). The microelectronic assembly 800 may include components disposed on a first face 840 of the circuit board 802 and an opposing second face 842 of the circuit board 802; generally, components may be disposed on one or both faces 840 and 842.

In some embodiments, the circuit board 802 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 802. In other embodiments, the circuit board 802 may be a non-PCB substrate. The microelectronic assembly 800 illustrated in FIG. 8 includes a package-on-interposer structure 836 coupled to the first face 840 of the circuit board 802 by coupling components 816. The coupling components 816 may electrically and mechanically couple the package-on-interposer structure 836 to the circuit board 802, and may include solder balls (as shown in FIG. 8), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 836 may include an integrated circuit component 820 coupled to an interposer 804 by coupling components 818. The coupling components 818 may take any suitable form for the application, such as the forms discussed above with reference to the coupling components 816. Although a single integrated circuit component 820 is shown in FIG. 8, multiple integrated circuit components may be coupled to the interposer 804; indeed, additional interposers may be coupled to the interposer 804. The interposer 804 may provide an intervening substrate used to bridge the circuit board 802 and the integrated circuit component 820.

The integrated circuit component 820 may be a packaged or unpackaged integrated circuit component that includes one or more integrated circuit dies (e.g., the die 602 of FIG. 6, the integrated circuit 700 of FIG. 7) and/or one or more other suitable components.

The unpackaged integrated circuit component 820 comprises solder bumps attached to contacts on the die. The solder bumps allow the die to be directly attached to the interposer 804. In embodiments where the integrated circuit component 820 comprises multiple integrated circuit dies, the dies can be of the same type (a homogeneous multi-die integrated circuit component) or of two or more different types (a heterogeneous multi-die integrated circuit component). In addition to comprising one or more processor units, the integrated circuit component 820 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies are sometimes referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof. A packaged multi-die integrated circuit component can be referred to as a multi-chip package (MCP) or multi-chip module (MCM).

Generally, the interposer 804 may spread connections to a wider pitch or reroute a connection to a different connection. For example, the interposer 804 may couple the integrated circuit component 820 to a set of ball grid array (BGA) conductive contacts of the coupling components 816 for coupling to the circuit board 802. In the embodiment illustrated in FIG. 8, the integrated circuit component 820 and the circuit board 802 are attached to opposing sides of the interposer 804; in other embodiments, the integrated circuit component 820 and the circuit board 802 may be attached to a same side of the interposer 804. In some embodiments, three or more components may be interconnected by way of the interposer 804.

In some embodiments, the interposer 804 may be formed as a PCB, including multiple metal layers separated from one another by layers of dielectric material and interconnected by electrically conductive vias. In some embodiments, the interposer 804 may be formed of an epoxy resin, a fiberglass-reinforced epoxy resin, an epoxy resin with inorganic fillers, a ceramic material, or a polymer material such as polyimide. In some embodiments, the interposer 804 may be formed of alternate rigid or flexible materials that may include the same materials described above for use in a semiconductor substrate, such as silicon, germanium, and other group III-V and group IV materials. The interposer 804 may include metal interconnects 808 and vias 810, including but not limited to through hole vias 810-1 (that extend from a first face 850 of the interposer 804 to a second face 854 of the interposer 804), blind vias 810-2 (that extend from the first or second faces 850 or 854 of the interposer 804 to an internal metal layer), and buried vias 810-3 (that connect internal metal layers).

In some embodiments, the interposer 804 can comprise a silicon interposer. Through silicon vias (TSV) extending through the silicon interposer can connect connections on a first face of a silicon interposer to an opposing second face of the silicon interposer. In some embodiments, an interposer 804 comprising a silicon interposer can further comprise one or more routing layers to route connections on a first face of the interposer 804 to an opposing second face of the interposer 804.

The interposer 804 may further include embedded devices 814, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 804. The package-on-interposer structure 836 may take the form of any of the package-on-interposer structures known in the art. In embodiments where the interposer is a non-printed circuit board

The integrated circuit assembly 800 may include an integrated circuit component 824 coupled to the first face 840 of the circuit board 802 by coupling components 822. The coupling components 822 may take the form of any of the embodiments discussed above with reference to the coupling components 816, and the integrated circuit component 824 may take the form of any of the embodiments discussed above with reference to the integrated circuit component 820.

The integrated circuit assembly 800 illustrated in FIG. 8 includes a package-on-package structure 834 coupled to the second face 842 of the circuit board 802 by coupling components 828. The package-on-package structure 834 may include an integrated circuit component 826 and an integrated circuit component 832 coupled together by coupling components 830 such that the integrated circuit component 826 is disposed between the circuit board 802 and the integrated circuit component 832. The coupling components 828 and 830 may take the form of any of the embodiments of the coupling components 816 discussed above, and the integrated circuit components 826 and 832 may take the form of any of the embodiments of the integrated circuit component 820 discussed above. The package-on-package structure 834 may be configured in accordance with any of the package-on-package structures known in the art.

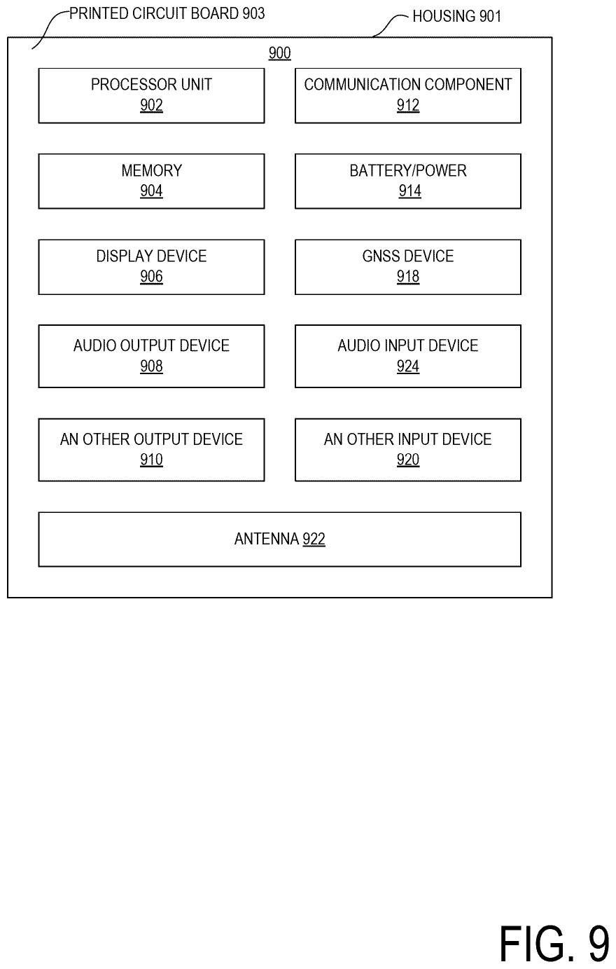

FIG. 9 is a block diagram of an example electrical device 900 that may include one or more of the embodiments disclosed herein. For example, any suitable ones of the components of the electrical device 900 may include one or more of the microelectronic assemblies 800, integrated circuit components 820, integrated circuits 700, integrated circuit dies 602, or structures disclosed herein. A number of components are illustrated in FIG. 9 as included in the electrical device 900, but any one or more of these components may be omitted or duplicated, as suitable for the application. In some embodiments, some or all the components included in the electrical device 900 may be attached to one or more motherboards, mainboards, printed circuit boards 903, or system boards. In some embodiments, one or more of these components are fabricated onto a single system-on-a-chip (SoC) die. In various embodiments, the electrical device 900 is enclosed by, or integrated with, a housing 901.

Additionally, in various embodiments, the electrical device 900 may not include one or more of the components illustrated in FIG. 9, but the electrical device 900 may include interface circuitry for coupling to the one or more components. For example, the electrical device 900 may not include a display device 906, but may include display device interface circuitry (e.g., a connector and driver circuitry) to which a display device 906 may be coupled. In another set of examples, the electrical device 900 may not include an audio input device 924 or an audio output device 908, but may include audio input or output device interface circuitry (e.g., connectors and supporting circuitry) to which an audio input device 924 or audio output device 908 may be coupled.

The electrical device 900 may include one or more processor units 902 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 902 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 900 may include a memory 904, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 904 may include memory that is located on the same integrated circuit die as the processor unit 902. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 900 can comprise one or more processor units 902 that are heterogeneous or asymmetric to another processor unit 902 in the electrical device 900. There can be a variety of differences between the processor units 902 in a system in terms of a spectrum of metrics of merit including architectural, microarchitectural, thermal, power consumption characteristics, and the like. These differences can effectively manifest themselves as asymmetry and heterogeneity among the processor units 902 in the electrical device 900.

In some embodiments, the electrical device 900 may include a communication component 912 (e.g., one or more communication components). For example, the communication component 912 can manage wireless communications for the transfer of data to and from the electrical device 900. The term “wireless” and its derivatives may be used to describe circuits, devices, systems, methods, techniques, communications channels, etc., that may communicate data using modulated electromagnetic radiation through a nonsolid medium. The term “wireless” does not imply that the associated devices do not contain any wires, although in some embodiments they might not.

The communication component 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 912 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 912 may operate in accordance with other wireless protocols in other embodiments. The electrical device 900 may include an antenna 922 to facilitate wireless communications and/or to receive other wireless communications (such as AM or FM radio transmissions).

In some embodiments, the communication component 912 may manage wired communications, such as electrical, optical, or any other suitable communication protocols (e.g., IEEE 802.3 Ethernet standards). As noted above, the communication component 912 may include multiple communication components. For instance, a first communication component 912 may be dedicated to shorter-range wireless communications such as Wi-Fi or Bluetooth, and a second communication component 912 may be dedicated to longer-range wireless communications such as global positioning system (GPS), EDGE, GPRS, CDMA, WiMAX, LTE, EV-DO, or others. In some embodiments, a first communication component 912 may be dedicated to wireless communications, and a second communication component 912 may be dedicated to wired communications.

The electrical device 900 may include battery/power circuitry 914. The battery/power circuitry 914 may include one or more energy storage devices (e.g., batteries or capacitors) and/or circuitry for coupling components of the electrical device 900 to an energy source separate from the electrical device 900 (e.g., AC line power).

The electrical device 900 may include a display device 906 (or corresponding interface circuitry, as discussed above). The display device 906 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 900 may include an audio output device 908 (or corresponding interface circuitry, as discussed above). The audio output device 908 may include any embedded or wired or wirelessly connected external device that generates an audible indicator, such speakers, headsets, or earbuds.

The electrical device 900 may include an audio input device 924 (or corresponding interface circuitry, as discussed above). The audio input device 924 may include any embedded or wired or wirelessly connected device that generates a signal representative of a sound, such as microphones, microphone arrays, or digital instruments (e.g., instruments having a musical instrument digital interface (MIDI) output). The electrical device 900 may include a Global Navigation Satellite System (GNSS) device 918 (or corresponding interface circuitry, as discussed above), such as a Global Positioning System (GPS) device. The GNSS device 918 may be in communication with a satellite-based system and may determine a geolocation of the electrical device 900 based on information received from one or more GNSS satellites, as known in the art.

The electrical device 900 may include another output device 910 (or corresponding interface circuitry, as discussed above). Examples of the other output device 910 may include an audio codec, a video codec, a printer, a wired or wireless transmitter for providing information to other devices, or an additional storage device.

The electrical device 900 may include another input device 920 (or corresponding interface circuitry, as discussed above). Examples of the other input device 920 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 900 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 900 may be any other electronic device that processes data. In some embodiments, the electrical device 900 may comprise multiple discrete physical components. Given the range of devices that the electrical device 900 can be manifested as in various embodiments, in some embodiments, the electrical device 900 can be referred to as a computing device or a computing system.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof.

As used herein, phrases such as “an embodiment,” “various embodiments,” “some embodiments,” and the like, indicate that some embodiments may have some, all, or none of the features described for other embodiments. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used in this application and the claims, a list of items joined by the term “at least one of” or the term “one or more of” can mean any combination of the listed terms. For example, the phrase “at least one of A, B or C” can mean A; B; C; A and B; A and C; B and C; or A, B, and C. Likewise, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

### EXAMPLES

Example 1 is an apparatus comprising: a reservoir configured to contain a liquid metal (LM); a plate attached to the reservoir, the plate having an arrangement of openings into the reservoir; and a needle detachably attached to an opening of the openings, the needle configured to receive the LM at a first end and dispense the LM at a second end.

Example 2 includes the subject matter of Example 1, wherein the arrangement of openings comprises a pinout.

Example 3 includes the subject matter of Example 1, wherein the arrangement of openings comprises a plurality of openings, individual openings being equally spaced in an array.

Example 4 includes the subject matter of Example 1, wherein the needle is one of a plurality of needles, and wherein individual of the needles are attached to one of the openings of the arrangement of openings.

Example 5 includes the subject matter of Example 1, wherein the reservoir includes a chamfer region located above the plate.

Example 6 includes the subject matter of Example 1, wherein the reservoir includes a chamfer region located above the plate, and the chamfer region is characterized by less than 70% of a reservoir height.

Example 7 includes the subject matter of Example 1, wherein the reservoir includes a chamfer region located above the plate, and the chamfer region is characterized by a slope of between 20 degrees and 60 degrees.

Example 8 includes the subject matter of Example 1, wherein the reservoir has a first diameter that is larger than a diameter of the plate.

Example 9 includes the subject matter of Example 1, wherein the reservoir has a cross-sectional area above a chamfer region that is larger than a cross-sectional area of the plate.

Example 10 includes the subject matter of Example 1, wherein the openings in the plate have been mechanically drilled.

Example 11 includes the subject matter of Example 1, wherein the openings have a corrosion-resistant coating.

Example 12 includes the subject matter of Example 1, wherein the needle comprises a nozzle tip at the second end.

Example 13 includes the subject matter of Example 1, wherein the needle comprises a nozzle tip at the second end, and the nozzle tip comprises a chamfer that is a function of a pinout.

Example 14 includes the subject matter of Example 1, wherein the needle is part of a needle assembly, and the needle assembly further comprises a locking mechanism that detachably attaches the needle on the first end to the plate.

Example 15 includes the subject matter of Example 14, wherein the locking mechanism comprises a Luer lock configured to attach to the plate.

Example 16 includes the subject matter of Example 14, wherein the locking mechanism comprises a clip lock configured to attach to the plate.

Example 17 includes the subject matter of Example 1, wherein the needle is part of a needle assembly, and the needle assembly further comprises an attachment means for detachably attaching the needle on the first end to the plate.

Example 18 includes the subject matter of Example 1, wherein the LM comprises gallium.

Example 19 includes the subject matter of Example 1, wherein the LM comprises gallium and oxygen.

Example 20 includes the subject matter of Example 1, wherein the LM comprises indium or tin.

Example 21 includes the subject matter of Example 1, wherein the LM comprises Ga₂O₃.

Example 22 is a method for dispensing liquid metal (LM), comprising: placing LM in a reservoir formed with a chamfer region, the chamfer region of the reservoir attached to a plate having a plurality of openings arranged in a pinout, the plate having a needle detachably attached to an opening of the plurality of openings; dispensing LM onto a target, via the needle; and inspecting the LM on the target.

Example 23 includes the subject matter of Example 22, further comprising detaching and replacing the needle.

Example 24 includes the subject matter of Example 22, further comprising detachably attaching the needle to the opening using a locking means.

Example 25 includes the subject matter of Example 22, wherein the needle is one of a plurality of needles, and further comprising detachably attaching a respective needle to individual openings of the pinout.

Example 26 is a liquid metal (LM) dispensing apparatus comprising: a reservoir comprising region of diminished cross-sectional area; a plate attached to the reservoir at the region of diminished cross-sectional area, the plate having an arrangement of openings into the reservoir; and at least two needles for dispensing the LM, individual of the at least two needles being detachably attached to a respective opening of the arrangement of openings in the plate.

Example 27 includes the subject matter of Example 26, further comprising a respective attachment means for individual of the needles.

Example 28 includes the subject matter of Example 26, wherein individual needles are detachably attached to the plate at a first end and comprise a nozzle at a second end.

Example 29 includes the subject matter of Example 26, wherein individual needles are detachably attached to the plate at a first end, and comprise a nozzle at a second end, and the nozzle comprises a chamfer that is a function of a dimension of an opening for an LM interconnect.

Example 30 includes the subject matter of Example 26, wherein the arrangement of openings matches a pinout for a LM interconnect on a substrate.

Example 31 includes the subject matter of Example 26, wherein the arrangement of openings matches a pinout for a Second Level Interconnect (SLI) or a First Level Interconnect (FLI).

Example 32 includes the subject matter of Example 26, wherein the arrangement of openings comprises a plurality of openings, individual openings being equally spaced in an array.

Example 33 includes the subject matter of Example 26, wherein the chamfer region is characterized by less than 70% of a height of the reservoir.

Example 34 includes the subject matter of Example 26, wherein the chamfer region is characterized by a slope of between 25 degrees and 60 degrees.

Example 35 includes the subject matter of Example 26, wherein dimensions of the reservoir are a function of the arrangement of openings and a material used for the LM.

Example 36 includes the subject matter of Example 26, wherein the openings in the plate are mechanically drilled.

Example 37 includes the subject matter of Example 26, wherein the openings have been coated to resist corrosion.

What is claimed is:

1. An apparatus comprising:
a reservoir configured to contain a liquid metal (LM);
a plate attached to the reservoir, the plate having an arrangement of openings into the reservoir; and
a needle detachably attached to an opening of the openings, the needle configured to receive the LM at a first end and dispense the LM at a second end.

2. The apparatus of claim 1, wherein the needle is one of a plurality of needles, and wherein individual of the needles are attached to one of the openings of the arrangement of openings.

3. The apparatus of claim 1, wherein the reservoir includes a chamfer region located above the plate.

4. The apparatus of claim 1, wherein the reservoir includes a chamfer region located above the plate, and the chamfer region is characterized by less than 70% of a reservoir height.

5. The apparatus of claim 1, wherein the reservoir includes a chamfer region located above the plate, and the chamfer region is characterized by a slope of between 20 degrees and 60 degrees.

6. The apparatus of claim 1, wherein the reservoir has a cross-sectional area above a chamfer region that is larger than a cross-sectional area of the plate.

7. The apparatus of claim 1, wherein the needle comprises a nozzle tip at the second end.

8. The apparatus of claim 1, wherein the needle is part of a needle assembly, and the needle assembly further comprises a locking mechanism that detachably attaches the needle on the first end to the plate.

9. The apparatus of claim 8, wherein the locking mechanism comprises a Luer lock configured to attach to the plate.

10. The apparatus of claim 8, wherein the locking mechanism comprises a clip lock configured to attach to the plate.

11. The apparatus of claim 1, wherein the needle is part of a needle assembly, and the needle assembly further comprises an attachment means for detachably attaching the needle on the first end to the plate.

12. The apparatus of claim 1, wherein the LM comprises gallium.

13. The apparatus of claim 1, wherein the LM comprises indium or tin.

14. A method for dispensing liquid metal (LM), comprising:
placing LM in a reservoir formed with a chamfer region, the chamfer region of the reservoir attached to a plate having a plurality of openings arranged in a pinout, the plate having a needle detachably attached to an opening of the plurality of openings;
dispensing LM onto a target, via the needle; and
inspecting the LM on the target.

15. The method of claim 14, further comprising detaching and replacing the needle.

16. The method of claim 14, further comprising detachably attaching the needle to the opening using a locking means.

17. The method of claim 14, wherein the needle is one of a plurality of needles, and further comprising detachably attaching a respective needle to individual openings of the pinout.

18. A liquid metal (LM) dispensing apparatus comprising:
a reservoir comprising region of diminished cross-sectional area;
a plate attached to the reservoir at the region of diminished cross-sectional area, the plate having an arrangement of openings into the reservoir; and
at least two needles for dispensing the LM, individual of the at least two needles being detachably attached to a respective opening of the arrangement of openings in the plate.

19. The LM dispensing apparatus of claim 18, further comprising a respective attachment means for individual of the needles.

20. The LM dispensing apparatus of claim 18, wherein individual needles are detachably attached to the plate at a first end and comprise a nozzle at a second end.

21. The LM dispensing apparatus of claim 18, wherein individual needles are detachably attached to the plate at a first end, and comprise a nozzle at a second end, and the nozzle comprises a chamfer that is a function of a dimension of an opening for an LM interconnect.

22. The LM dispensing apparatus of claim 18, wherein the arrangement of openings matches a pinout for a LM interconnect on a substrate.

23. The LM dispensing apparatus of claim 18, wherein the arrangement of openings matches a pinout for a Second Level Interconnect (SLI) or a First Level Interconnect (FLI).

24. The LM dispensing apparatus of claim 18, wherein the chamfer region is characterized by less than 70% of a height of the reservoir.

25. The LM dispensing apparatus of claim 18, wherein the openings have been coated to resist corrosion.
